(19) United States
(12) Patent Application Publication
(10) Pub. No.: US 2025/0338101 A1
(43) Pub. Date: Oct. 30, 2025

(54) COUPLING DEVICE FOR NEAR-FIELD COMMUNICATION BETWEEN A CONTACTLESS COMMUNICATING DEVICE AND A RADIO- FREQUENCY TRANSMITTER

(71) Applicant: SMART PACKAGING SOLUTIONS, Rousset (FR)

(72) Inventors: Anthony DESJOUIS, Rousset (FR); Stephan DANLER BAUMGARTNER, Rousset (FR); Guillaume GERIN, Rousset (FR)

(73) Assignee: SMART PACKAGING SOLUTIONS, Rousset (FR)

(21) Appl. No.: 18/864,576

(22) PCT Filed: May 10, 2023
(86) PCT No.: PCT/EP2023/062494

§ 371 Date: Nov. 11, 2024

(30) Foreign Application Priority Data
May 11, 2022 (FR) FR2204476

(51) Int. Cl. H04W 4/80

(52) U.S. Cl. CPC H04W 4/80

(57) ABSTRACT

The invention relates to a coupling device for near-field communication between a contactless communicating device and a radio transmitter, the device comprising:—a flexible support; and—an antenna on the support. The device essentially further comprises:—positioning means for the relative positioning of the coupling device with the communicating device or with the transmitter, the relative positioning means comprising at least one from among securing means and visual referencing means, the antenna of the coupling device then being in a relative position such that when the near-field communication antenna of the communicating device is powered by the transmitter, the antenna of the coupling device is arranged in the field lines of the contactless communicating device and in the field lines of the transmitter.

The present invention relates to the field of near-field communication between a contactless communicating device and a radio-frequency transmitter.

This technology is well known in banking applications. Typically in this case, the contactless communicating device is a smart card, debit card and/or credit card. The smart card is flat, has two dimensions and comprises four corners, which are in this case rounded. The format of smart cards is usually standardized.

The smart card comprises a near-field communication antenna.

The contactless communicating device may also be provided in the form of an object, notably a fashion accessory, in particular a ring.

In banking applications, the radio-frequency transmitter is for example a smart card reader, integrated into an electronic payment terminal available in any type of business. However, technological advances mean that smartphones can also be transmitters. Unless otherwise specified, the term “transmitter” is understood here to mean, without distinction, a reader for a contactless communicating device, notably a smart card, or a smartphone.

The radio-frequency transmitter comprises a near-field communication antenna.

It should be noted that the operating principle for banking applications described below also exists for official identity documents, i.e. documents issued by an authority (state, government, ministry, etc.), for example an identity card, a passport, a driver's license, etc., or for unofficial identity documents, for example a membership card, a travel card, etc., where the identity document comprises a chip and a near-field communication antenna, to enable communication between the chip and a radio-frequency transmitter.

The term “smart card” is therefore understood to mean, without distinction, a smart card for a banking or identification application, notably a biometric application. The same applies to “contactless communicating device”.

Generally, the frequency of the RFID carrier between the radio-frequency transmitter and the contactless communicating device is between 13 MHz and 14 MHz; the antenna of the contactless communicating device and the antenna of the radio-frequency transmitter form two tuned resonant circuits, the resonant frequency of which is close to the carrier frequency (11-19 MHz).

To enable near-field communication between the contactless communicating device and the radio-frequency transmitter, the radio-frequency transmitter emits a magnetic field. When the contactless communicating device is in the field lines of the radio-frequency transmitter, an electric current is created therein, it is then powered by the radio-frequency transmitter, and it also emits a magnetic field. There is then a coupling between the contactless communicating device and the radio-frequency transmitter.

However, there are more and more parasitic elements that can disturb the coupling. Even in a reader for a contactless communicating device such as an automated cash dispenser, in which the relative position of the contactless communicating device, in this case a smart card, and the radio-frequency transmitter is mechanically controlled, there may be field disturbing elements, for example adjoining magnetic fields, metallic elements or electrically conductive elements which disturb the coupling. The same is true in a reader for a contactless communicating device such as a payment terminal, for example at a store.

A fortiori when the radio-frequency transmitter is a smartphone, on the one hand the magnetic field emitted thereby is generally less intense than the magnetic field emitted by a smart card reader and, on the other hand, controlling the relative position of the contactless communicating device and the radio-frequency transmitter is more difficult since it is usually done manually. Furthermore, the position of the near-field communication antenna of a smartphone is not standardized, and is generally unknown to the end user thereof.

For example, the exchange of “large” data between a contactless communicating device and a reader, for example biometric data, can be compromised due to connection losses during the exchange phase. The same is true for a bank transaction.

There is therefore a need to improve the coupling between a contactless communicating device and a radio-frequency transmitter, for mechanically controlled or uncontrolled applications, i.e. in a constrained environment.

### SUMMARY OF THE INVENTION

More precisely, according to a first subject thereof, the invention relates to a coupling device for near-field communication between:
a. a contactless communicating device (20) comprising a near-field communication module and antenna (21), optionally in the form of a stand-alone module, and
b. a radio-frequency transmitter (30) comprising a near-field communication antenna (31) capable of emitting a field along field lines,
the coupling device (10) comprising:
a flexible support (11),
a near-field communication antenna (12), preferably arranged on the support (11).

It is essentially characterized in that the coupling device (10) further comprises:
means for positioning said coupling device (10) relative to said contactless communicating device (20) or to said radio-frequency transmitter (30), said relative positioning means comprising at least one of the following:
attachment means, and
visual referencing means,
said relative positioning means being configured to arrange the near-field communication antenna (12) of said coupling device (10) relative to the near-field communication antenna (21) of the contactless communicating device (20) and/or to the near-field communication antenna (31) of the radio-frequency transmitter (30), so that:
when the near-field communication antenna (21) of the contactless communicating device (20) is in the field of the near-field communication antenna (31) of said radio-frequency transmitter (30), then
said near-field communication antenna (21) of the contactless communicating device (20) emits a field along field lines; and
the near-field communication antenna (12) of the coupling device (10) is arranged both in the field lines of the contactless communicating device (20) and in the field lines of said radio-frequency transmitter (30);
the coupling device (10) acting as a waveguide to optimize the coupling factor between the radio-frequency transmitter (30) and the contactless communicating device (20).

Provision may be made that:
the support (11) comprises an upper face and a lower face, at least one of which has a flat part, and
the relative positioning means comprise attachment means which comprise a set of at least one stop (15), arranged on the flat part of one or other of the faces of the support (11), such that the contactless communicating device (20) can abut against said set of at least one stop (15).

Provision may be made that:
the contactless communicating device (20) comprises a flat part comprising at least one corner, and
the relative positioning means comprise attachment means which comprise a set of at least one slot (14) in the support (11), each slot (14) being configured to enable a corner of the contactless communicating device (20) to be inserted therein.

The support (11) may have two dimensions, at least one of which is larger than the smaller dimension of the contactless communicating device (20).

The support (11) may have two dimensions, at least one of which is smaller than the smaller dimension of the contactless communicating device (20).

The relative positioning means may comprise attachment means which comprise an adhesive layer (13).

According to another of the subjects thereof, the invention relates to a contactless communicating device (20) for contactless payment or contactless identification, comprising a near-field communication module and antenna (21), the device being provided in the form of:
a fashion accessory, notably an item of jewelry, and in particular a watch, a key ring, a bracelet, a pendant or a ring; or
a smart card,
wherein:
the contactless communicating device (20) comprises a coupling device (10) according to the invention, and
the support (11) is attached to the contactless communicating device (20), with or without an adhesive layer (13).

According to another of the subjects thereof, the invention relates to a radio-frequency transmitter (30) comprising a near-field communication antenna (31) capable of emitting a field along field lines, comprising a coupling device (10) according to the invention, wherein:
the coupling device (10) is attached to the near-field communication antenna (31) of said transmitter (30);
said radio-frequency transmitter (30) being for example a reader for a contactless communicating device (20).

Provision may be made that:
said radio-frequency transmitter (30) is a smartphone comprising a frame (32), and
the coupling device (10) is attached to said smartphone or to said frame (32),
and if the smartphone comprises a protective case, the coupling device (10) may optionally be attached to the protective case.

According to another of the subjects thereof, the invention relates to a near-field communication system comprising:
a coupling device (10) according to the invention,
a contactless communicating device (20) for contactless payment or contactless identification, comprising a near-field communication module and antenna (21), and
a display package;
wherein:
the contactless communicating device (20) is provided in the form of:
a fashion accessory, notably an item of jewelry, and in particular a watch, a key ring, a bracelet, a pendant or a ring; or
a smart card,
wherein the contactless communicating device (20) may comprise a coupling device (10) according to the invention,
and wherein:
the display package has a shape that locally conforms to the shape of the contactless communicating device (20), the display package comprising said coupling device (10).

Finally, the invention also relates to a method for near-field communication coupling between a contactless communicating device (20) and a smartphone acting as a radio-frequency transmitter (30) comprising a near-field communication antenna (31) capable of emitting a field along field lines, using a coupling device (10) according to the invention,
the method further comprising the steps of:
attaching the coupling device (10) to the smartphone or to the contactless communicating device (20),
using the smartphone to emit a radio-frequency field,
moving said smartphone and said contactless communicating device (20) in parallel planes, at a distance such that said contactless communicating device (20) is in the field lines of said smartphone,
determining the coupling factor between said smartphone and said contactless communicating device (20) for a set of relative positions, and
identifying the relative position at which the coupling factor is maximum.

Other features and advantages of the present invention will become more clearly apparent on reading the description below, given by way of non-limiting example with reference to the attached figures.

### DESCRIPTION OF THE DRAWINGS

FIG. 1 illustrates an embodiment of a coupling device according to the invention,

FIG. 2 illustrates a method of assembling an embodiment of a device according to the invention with a smart card,

FIG. 3 illustrates another method of assembling an embodiment of a device according to the invention with a smart card,

FIG. 4 illustrates the relative positioning of a coupling device according to the invention when a smart card is in a smart card reader such as a bank automated cash dispenser,

FIG. 5A illustrates an exploded view of a system according to the invention,

FIG. 5B illustrates FIG. 5A in a partially exploded view.

### DETAILED DESCRIPTION

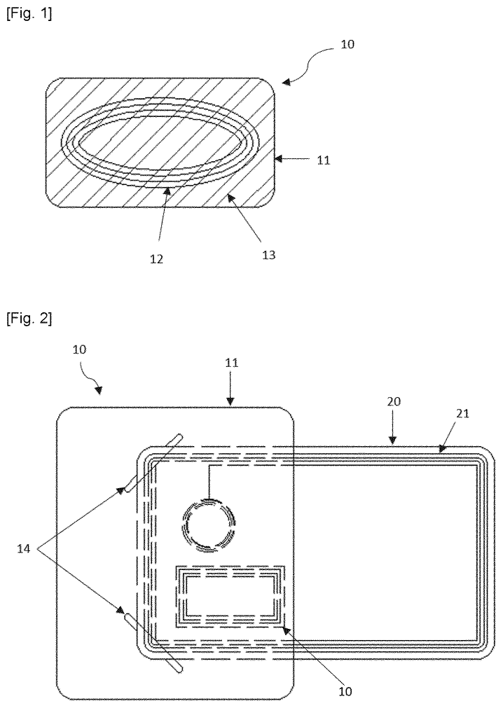

FIG. 1 illustrates an embodiment of a coupling device 10 according to the invention.

The device according to the invention is a coupling device 10 for near-field communication between a contactless communicating device 20, or a contactless communicating object 20, and a radio-frequency transmitter 30, for example a smart card reader or a smartphone, hereinafter referred to as “transmitter” for conciseness.

The transmitter comprises a near-field communication antenna 31, hereinafter referred to as “antenna” for conciseness.

Typically, a contactless communicating device is provided in the form of a smart card, or in the form of a fashion accessory, notably an item of jewelry, and in particular a watch, a key ring, a bracelet, a pendant or a ring.

The contactless communicating device is used for fiduciary payment purposes, for example a bank card or a payment ring, etc., or to identify the bearer, for example a badge, a membership smart card, etc.

A smart card is flat and has two dimensions. It has four corners, which are usually rounded. The format of a smart card is often standardized.

The coupling device 10 according to the invention comprises a flexible support 11, preferably flat, and a near-field communication antenna arranged on said support 11. The support 11 comprises an upper face and a lower face.

The coupling device 10 is a passive resonant circuit (i.e. with no chip) tuned to a natural frequency, preferably between 11 MHz and 19 MHz.

The antenna 12 of the coupling device 10 is a series RLC circuit. Preferably, the inductance is between 100 nH and 10 μH, and preferably 3 μH or 4 μH. The capacitance is between 5 pF and 300 pF, and preferably 30 pF.

In FIG. 1, the coupling device 10 has a shape similar to the shape of a smart card that is for example compliant with standard ISO/IEC 7810, known as ID-1, and the antenna has an oval shape. This example is illustrative and non-limiting. The support 11 and the antenna can each have any type of two-dimensional shape, provided that the antenna is supported by the support 11.

The coupling device 10 further comprises means for positioning said coupling device 10 relative to a contactless communicating device 20 or to a transmitter 30.

These relative positioning means are configured to arrange the near-field communication antenna of said coupling device 10 in a clever relative position with respect to the antenna 21 of the contactless communicating device 20 or the antenna 31 of the transmitter 30.

Indeed, as seen above, it is possible for near-field communication between a contactless communicating device 20 and a transmitter 30 to be disturbed, or even made impossible.

To overcome this drawback, the coupling device 10 according to the invention acts as a waveguide between the waves of the transmitter 30 and the contactless communicating device 20.

For this purpose, when the antenna 22 of the contactless communicating device 20 is powered by said transmitter 30, then the near-field communication antenna 12 of the coupling device 10 is arranged in the field lines of the contactless communicating device 20 and in the field lines of said transmitter 30, as illustrated in FIG. 4.

The coupling device 10 thus enables a coupling between the transmitter 30 and the contactless communicating device 20, and more precisely between the transmitter 30 and the coupling device 10 on the one hand, and between the coupling device 10 and the contactless communicating device 20 on the other hand.

This provides a non-zero coupling coefficient between the coupling device 10 and the contactless communicating device 20 on the one hand, and a non-zero coupling coefficient between the coupling device 10 and the transmitter 30 on the other hand.

To enable this, provision is made for the relative positioning means to comprise:
attachment means,
visual referencing means, or
a combination of attachment means and visual referencing means.

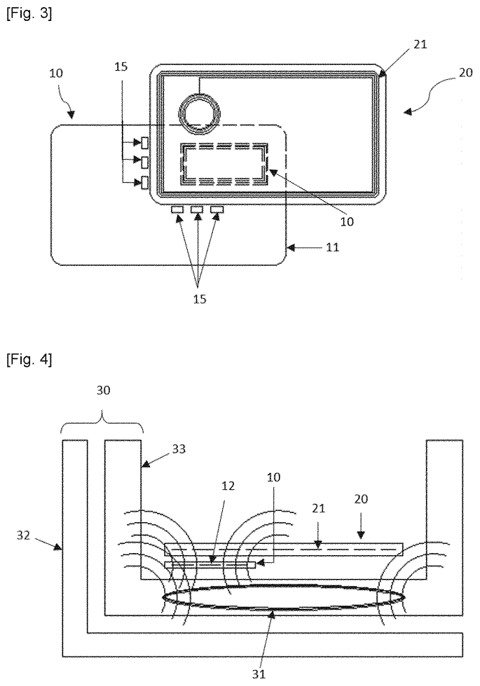

The attachment means comprise for example a set of at least one stop 15 arranged on one or other of the faces of the support 11. The stop 15 or the stops 15 may for example be bosses on the face of the support 11, for example as illustrated in FIG. 3.

Alternatively or in combination, the attachment means may comprise a set of at least one slot 14 in the support 11, each slot 14 being configured for example to enable a corner of a smart card to be inserted therein, as illustrated in FIG. 2.

In this case, two slots 14 are provided, enabling two adjacent corners of a smart card to be inserted.

The position of the antenna 21 of a smart card is generally known. The position of the antenna 12 of the coupling device 10 is known. It is therefore easy to position the attachment means so that the antenna 12 of the coupling device 10 is in the field lines of the antenna 21 of a smart card, when it is powered.

The visual referencing means comprise for example a drawing of all or part of the perimeter of a smart card, allowing a user to intuitively understand the positioning of the card on the support 11.

Any other type of visual reference may be used, for example a set of lines, crosses, graphic symbols (notably arrows), etc. enabling the smart card to be positioned on the support 11.

For example, the support 11 may be provided in the form of a letter accompanying the supply of the smart card to a user, for example a sheet of A4 paper comprising an antenna 12, said sheet being provided with slots 14 and/or visual reference (not illustrated) enabling the smart card to be positioned with respect to the support 11 in a predefined relative position.

In this case, the dimensions of the support 11 are larger than the dimensions of a smart card, but this feature is not obligatory. Provided that the relative positioning allows the coupling device 10 to be in field lines of the smart card, then the support 11 can have any dimensions, including dimensions smaller than the smart card.

The support 11 has two dimensions, so at least one of them can be larger than the smaller dimension of the smart card.

It is also possible for each dimension of the support 11 to be smaller than the smaller dimension of the smart card.

In this case, it is advantageous for the relative positioning means to comprise attachment means which comprise an adhesive layer 13, preferably allowing temporary attachment between the coupling device 10 and the smart card, in such a way that the flat flexible support 11 of the coupling device 10 is glued to one face of the smart card by said adhesive layer 13.

The coupling device 10 can thus be provided in the form of a self-adhesive label, arranged on one face of the smart card. Like the self-adhesive labels which protect the chip before its first use, the coupling device 10 in the form of a label can advantageously also be removed, for example once the enrolment phase has ended.

The position of the coupling device 10 on the smart card is advantageously predetermined.

The coupling device 10 may comprise visual referencing means which enable the smart card to be positioned with respect to these visual referencing means. Alternatively or in combination, the smart card may comprise visual referencing means which enable the coupling device 10 to be positioned with respect to these visual referencing means, for example with respect to at least one edge or at least one corner of the smart card; or, if the smart card is personalized, with respect to a personalization element. Ad hoc visual references may also be provided on at least one of the smart card and the coupling device 10, for example lines or arrows on one face of the smart card and on the coupling device 10, wherein said arrows have to be arranged to face each other in order to obtain an optimum coupling factor.

Preferably, the coupling device 10 and the smart card are attached together during manufacture or at the latest during the personalization of the smart card, so that the end user, the bearer of the smart card, receives a smart card provided with the coupling device 10 already in position.

However, the coupling device 10 may be permanently attached to the smart card, notably since the manufacturer of coupling devices is often different from the manufacturer of smart cards.

To this end, the flat flexible support 11 may be integrated into the smart card, with or without an adhesive layer 13. More generally, the coupling device 10 may be integrated into the contactless communicating device 20.

Thus, a coupling device 10 according to the invention and a smart card may be attached together temporarily or permanently.

Similarly, a coupling device 10 according to the invention and a radio-frequency transmitter 30 may be attached together temporarily or permanently.

In a first embodiment, illustrated in FIG. 4, the radio-frequency transmitter 30 is a smart card reader, comprising a near-field communication antenna 31 housed in a plastic support 33, and which comprises a frame 32.

In this case, the coupling device 10 is preferably glued to the support 11 of the near-field communication antenna of said smart card reader, typically in a manner similar to the embodiment in which the coupling device 10 is glued to one face of a smart card.

In this embodiment, the coupling device 10 may have any dimensions, i.e. both dimensions thereof are larger than the dimensions of a smart card, or both dimensions thereof are smaller than the dimensions of a smart card, or only one of the two dimensions is larger than one of the dimensions of a smart card.

In a second embodiment, the radio-frequency transmitter 30 is a smartphone.

A smartphone comprises a frame 32, and often a protective case, which protects the frame 32 and is removable.

In this embodiment, the coupling device 10 may be attached to said smartphone.

For example, the coupling device 10 may be integrated into the smartphone, preferably with an adhesive layer 13.

The coupling device 10 may also be attached to the frame 32. For example, the coupling device 10 may be glued to the inner face or to the outer face of the frame 32 using an adhesive layer 13.

In a manner similar to the positioning of the coupling device 10 on a smart card, the position of the coupling device 10 on the frame 32 or in the smartphone is preferably predetermined.

If the smartphone comprises a protective case, the coupling device 10 can also be attached to the protective case, typically glued to the inner face or to the outer face of the protective case.

For example, the case or the frame 32 comprises visual referencing means for positioning the coupling device 10, as described above.

For near-field communication coupling between a smart card and a transmitter using a coupling device 10 according to the invention, it is desirable that the near-field communication antenna of said coupling device 10 be in a relative position such that when the radio-frequency transmitter 30 emits a field, then the antenna of the smart card and the antenna of the coupling device 10 are arranged in the field lines of the radio-frequency transmitter 30, the antenna of the coupling device 10 also being in the field lines of the smart card.

For this purpose, in particular when the transmitter is a smartphone, and therefore handleable, the following method may be implemented, typically by the user of the smartphone.

Firstly, the coupling device 10 is attached to the smartphone or to the smart card.

The smartphone can then emit a radio-frequency field enabling stable communication between the smart card and the smartphone using the coupling device 10 according to the invention which, like a waveguide, orients the electromagnetic field emitted by the smartphone.

To optimize the coupling factors, said smartphone and said smart card are then moved in parallel planes, at a distance such that said smart card remains in the field lines of said smartphone, the coupling device 10 remaining attached to the smartphone or to the smart card.

During this relative movement, the coupling factor between said smartphone and said smart card can be determined for a set of relative positions, for example by a software application installed on the smartphone.

This makes it possible to identify the relative position at which the coupling factor is maximum.

For example, it is possible to emit a sound or to display a graphic representation on the display screen of the smartphone, the sound or graphic representation representing the value of the coupling factor.

This enables the user of the smartphone to very easily position the smartphone relative to the smart card using the coupling device 10, which acts as a waveguide, so that the coupling factor between the smartphone and the smart card is optimal, i.e. between two predetermined values around the maximum.

The coupling device 10 is not an amplifier but a waveguide which orients the field lines in the optimum position; the coupling device 10 receives both the radio-frequency field of the transmitter and the radio-frequency field of the smart card.

The invention is not limited to the embodiments described above.

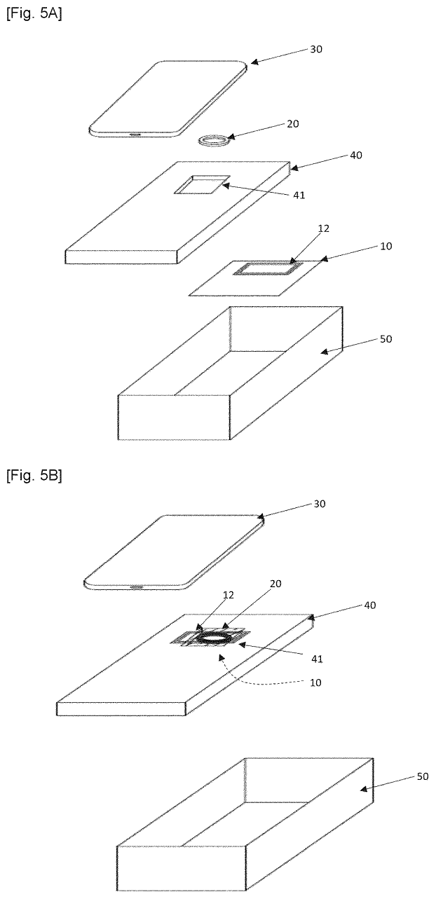

For example, the contactless communicating device 20 may be provided in the form of a fashion accessory, notably an item of jewelry, and in particular a watch, a key ring, a bracelet, a pendant or, as illustrated in FIG. 5A and FIG. 5B, a ring.

The principle of stops 15 is applicable to such contactless communicating devices 20.

In FIGS. 5A and 5B, the contactless communicating device 20 is a ring and the transmitter 30 is a smartphone. The coupling device 10 is advantageously used for the tokenization of the ring 20 with the smartphone 30, tokenization being a process enabling a critical data element to be replaced by an equivalent element that has no intrinsic value or exploitable meaning once it has left the system, which in the banking field involves uploading a set of at least one token into the ring, which token can be single use or multiple use. Although a payment takes about 300 ms with a payment ring 20, tokenization is a process that can take about 3 to 15 seconds. It is important that the relative position of the ring 20 and the smartphone 30 be stable in this interval during this tokenization operation.

To this end, a box 50 can advantageously be used, in particular the delivery box in which the smartphone 30 is delivered, comprising a keying device, or template, for the smartphone, for example in the form of a display package 40. An additional keying device may be provided for the contactless communicating device 20, for example in the form of a recess 41 in the display package 40, equivalent to the stops 15 described above.

The display package 40 has a front face on which the smartphone 30 is placed, and a rear face on which the coupling device 10 is arranged, for example by gluing.

### Nomenclature

10 Coupling device
11 Flat flexible support
12 Near-field communication antenna of the coupling device
13 Adhesive layer
14 Slot
15 Stop
20 Contactless communicating device
21 Near-field communication antenna of the contactless communicating device
30 Radio-frequency transmitter
31 Near-field communication antenna of the radio-frequency transmitter
32 Frame of the radio-frequency transmitter
33 Plastic support
40 Display package
41 Recess in the display package
50 Box

1. A coupling device for near-field communication between:
a. a contactless communicating device comprising a near-field communication module and antenna, optionally in the form of a stand-alone module, and
b. a radio-frequency transmitter comprising a near-field communication antenna capable of emitting a field along field lines,
the coupling device comprising:
a flexible support,
a near-field communication antenna, preferably arranged on the support,
characterized in that the coupling device further comprises:
means for positioning said coupling device relative to said contactless communicating device or to said radio-frequency transmitter, said relative positioning means comprising at least one of the following:
attachment means, and
visual referencing means,
said relative positioning means being configured to arrange the near-field communication antenna of said coupling device relative to the near-field communication antenna of the contactless communicating device and/or to the near-field communication antenna of the radio-frequency transmitter, so that:
when the near-field communication antenna of the contactless communicating device is in the field of the near-field communication antenna of said radio-frequency transmitter, then
said near-field communication antenna of the contactless communicating device emits a field along field lines; and
the near-field communication antenna of the coupling device is arranged both in the field lines of the contactless communicating device and in the field lines of said radio-frequency transmitter;
the coupling device acting as a waveguide to optimize the coupling factor between the radio-frequency transmitter and the contactless communicating device.

2. The coupling device as claimed in claim 1, wherein:
the support comprises an upper face and a lower face, at least one of which has a flat part, and
the relative positioning means comprise attachment means which comprise a set of at least one stop, arranged on the flat part of one or other of the faces of the support, such that the contactless communicating device can abut against said set of at least one stop.

3. The coupling device as claimed in in claim 1, wherein:
the contactless communicating device comprises a flat part comprising at least one corner, and
the relative positioning means comprise attachment means which comprise a set of at least one slot in the support, each slot being configured to enable a corner of the contactless communicating device to be inserted therein.

4. The coupling device as claimed claim 1, wherein the support has two dimensions, at least one of which is larger than the smaller dimension of the contactless communicating device.

5. The coupling device as claimed in claim 1, wherein the support has two dimensions, at least one of which is smaller than the smaller dimension of the contactless communicating device,
and wherein the relative positioning means comprise attachment means which comprise an adhesive layer.

6. A contactless communicating device for contactless payment or contactless identification, comprising a near-field communication module and antenna, the device being provided in the form of:
a fashion accessory, notably an item of jewelry, and in particular a watch, a key ring, a bracelet, a pendant or a ring; or
a smart card,
wherein:
the contactless communicating device comprises a coupling device as claimed in claim 1, and
the support is attached to the contactless communicating device, with or without an adhesive layer.

7. A radio-frequency transmitter comprising a near-field communication antenna capable of emitting a field along field lines, comprising a coupling device as claimed in claim 1, wherein:
the coupling device is attached to the near-field communication antenna of said transmitter;
said radio-frequency transmitter being for example a reader for a contactless communicating device.

8. A near-field radio-frequency transmitter, wherein:
said radio-frequency transmitter is a smartphone comprising a frame, and
the coupling device is attached to said smartphone or to said frame,
and if the smartphone comprises a protective case, the coupling device may optionally be attached to the protective case.

9. A near-field communication system comprising:
a coupling device as claimed in claim 1,
a contactless communicating device for contactless payment or contactless identification, comprising a near-field communication module and antenna, and
a display package;
wherein:
the contactless communicating device is provided in the form of:
a fashion accessory, notably an item of jewelry, and in particular a watch, a key ring, a bracelet, a pendant or a ring; or
a smart card,
wherein the contactless communicating device may comprise a coupling device,
and wherein:
the display package has a shape that locally conforms to the shape of the contactless communicating device, the display package comprising said coupling device.

10. A method for near-field communication coupling between a contactless communicating device and a smartphone acting as a radio-frequency transmitter comprising a near-field communication antenna capable of emitting a field along field lines, using a coupling device as claimed in claim 1,
the method comprising steps of:
attaching the coupling device to the smartphone or to the contactless communicating device,
using the smartphone to emit a radio-frequency field,
moving said smartphone and said contactless communicating device in parallel planes, at a distance such that said contactless communicating device is in the field lines of said smartphone,
determining the coupling factor between said smartphone and said contactless communicating device for a set of relative positions, and
identifying the relative position at which the coupling factor is maximum.
